(19) United States
(12) Patent Application Publication
(10) Pub. No.: US 2014/0159876 A1
(43) Pub. Date: Jun. 12, 2014

(54) METHOD AND APPARATUS FOR SETTING UP CONFIGURATION OF MACHINE TO MACHINE COMMUNICATION

(71) Applicant: ELECTRONICS AND TELECOMMUNICATIONS RESEARCH INSTITUTE, Daejeon (KR)

(72) Inventor: Se Won OH, Daejeon (KR)

(21) Appl. No.: 13/909,734

(22) Filed: Jun. 4, 2013

(30) Foreign Application Priority Data
Dec. 10, 2012 (KR) 10-2012-0143000

(51) Int. Cl. G06K 7/10

(52) U.S. Cl. CPC G06K 7/10198
USPC 340/10.51

(57) ABSTRACT

A method of setting up and changing a configuration used when an M2M device accesses a communication network to transmit and receive data is provided. An M2M module may read a configuration recorded in a tag memory of an M2M tag chip to set up an M2M device through the recorded configuration. When a plurality of M2M devices are forwarded, the same configuration may be recorded in the M2M devices and identifiers may be designated to the M2M devices.

### CROSS-REFERENCE TO RELATED APPLICATION

This application claims priority to and the benefit of Korean Patent Application No. 10-2012-0143000 filed in the Korean Intellectual Property Office on Dec. 10, 2012, the entire contents of which are incorporated herein by reference.

### BACKGROUND OF THE INVENTION

(a) Field of the Invention

The present invention relates to a method and an apparatus for setting up and changing a configuration of machine to machine (M2M) communication.

(b) Description of the Related Art

Machine to machine (M2M) communication means communication between devices without a human being intervening. Recently, M2M communication has referred to wired/wireless communication between electronic devices or communication between a device and a machine controlled by a human being in a field such as machine-type communication (MTC) or the Internet of things (IOT).

In M2M communication, data is transmitted between a device (an M2M device including an M2M module) and a service server through wired/wireless communication so that data (a sensor value, event data, etc.) collected by the device accessing a wired/wireless Internet network may be transmitted to and received from the service server.

For example, in a remote meter reading service to determine an amount of electricity use, a meter corresponding to the M2M device may transmit meter reading data to the service server through the wired/wireless communication network. In addition, in an interior automatic temperature controlling service, a temperature controller corresponding to the M2M device may transmit collected temperature data to the service server through the wired/wireless communication network.

A sensor node of a sensor network system may correspond to the M2M device. At this time, the sensor node may transmit sensed data to a gateway of the sensor network in accordance with a configuration such as an identifier of the sensor node, a routing protocol of the sensor network, a duty cycle, a data transfer rate, and a sensing interval.

Therefore, a method of setting up and changing the configuration may be defined when the M2M device is driven.

### SUMMARY OF THE INVENTION

Therefore, according to the present invention, a method and an apparatus for setting up and changing a configuration used when an M2M device accesses a communication network to transmit and receive data are provided.

According to an exemplary embodiment of the present invention, a method of recording an initial configuration in an M2M tag chip through a radio frequency identification (RFID) reader is provided. The method of recording the initial configuration in the M2M tag chip through the RFID reader includes transmitting an identifier of an M2M module including the M2M tag chip or a configuration of the M2M module to the RFID reader, receiving the initial configuration determined based on the identifier or the configuration from the RFID reader, and changing the configuration of the M2M module into the initial configuration and storing the initial configuration.

The method of recording the initial configuration may further include informing the RFID reader whether a change into the initial configuration is successfully performed.

The method of recording the initial configuration may further include informing a processing unit included in the M2M module whether the change into the initial configuration is successfully performed after power is supplied to the M2M module.

According to another exemplary embodiment of the present invention, a method of setting up an M2M module through an initial configuration stored in an M2M tag chip included in an M2M module is provided. The method of setting up the M2M module includes reading the initial configuration after power is applied to the M2M module, setting up the M2M module based on the read initial configuration, and connecting the M2M module to an M2M network in accordance with the set up initial configuration.

The method of setting up the M2M module may further include storing the set up initial configuration.

According to another exemplary embodiment of the present invention, an M2M module for connecting a device and an M2M network is provided. The M2M module includes an M2M tag chip for storing an initial configuration for setting up the M2M module, a processing unit for reading an initial configuration from the M2M tag chip after power is applied to the M2M module and setting up the M2M module based on the read initial configuration, and an M2M-tag communication interface for connecting the M2M tag chip and the processing unit.

In the M2M module, the M2M tag chip is connected to a tag antenna for transmitting and receiving a radio frequency (RF) signal to and from a radio frequency identification (RFID) reader, and may include an RF analog module for transmitting and receiving an RF signal to and from the tag antenna, a digital module for converting the signal transmitted by the RF analog module into a digital signal, and a tag memory for storing a configuration of the M2M module in accordance with the digital signal.

In the M2M module, the tag memory may inquire or record data in accordance with the digital signal, and may store an identifier of an M2M tag chip.

In the M2M module, the processing unit may connect the set up M2M module to the M2M network based on the initial configuration.

In the M2M module, an M2M-tag communication interface may connect the M2M tag chip and the processing unit by a serial method such as a universal asynchronous receiver transmitter (UART), a serial peripheral interface (SPI), and an inter-integrated circuit (I²C), or a parallel method such as an industry standard architecture (ISA) and an advanced technology attachment (ATA).

The M2M module may further include a memory for storing the initial configuration and temporary information that may be generated for operation time of the M2M module.

The M2M module may further include an M2M input/output interface for connecting the M2M device and the M2M network and the M2M module.

### BRIEF DESCRIPTION OF THE DRAWINGS

FIG. 1 is a view illustrating a machine to machine (M2M) communication system according to an exemplary embodiment of the present invention.

FIG. 2 is a view illustrating an M2M communication system applied to a sensor network system according to an exemplary embodiment of the present invention.

FIG. 3 is a view illustrating an M2M communication system applied to a home appliance according to an exemplary embodiment of the present invention.

FIG. 4 is a block diagram illustrating an M2M module according to an exemplary embodiment of the present invention.

FIG. 5 is a block diagram illustrating an M2M tag chip according to an exemplary embodiment of the present invention.

FIG. 6 is a flowchart illustrating processes of inquiring and setting up a configuration of an M2M tag chip according to an exemplary embodiment of the present invention.

FIG. 7 is a flowchart illustrating processes of initially setting up an M2M module according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the entire specification, unless explicitly described to the contrary, the word “comprise” and variations such as “comprises” or “comprising” will be understood to imply the inclusion of stated elements but not the exclusion of any other elements. In addition, the terms “ . . . unit”, “ . . . er”, “module”, and “block” specified in the specification mean a unit that processes at least one function or operation, which may be realized by hardware or software or a combination of hardware and software.

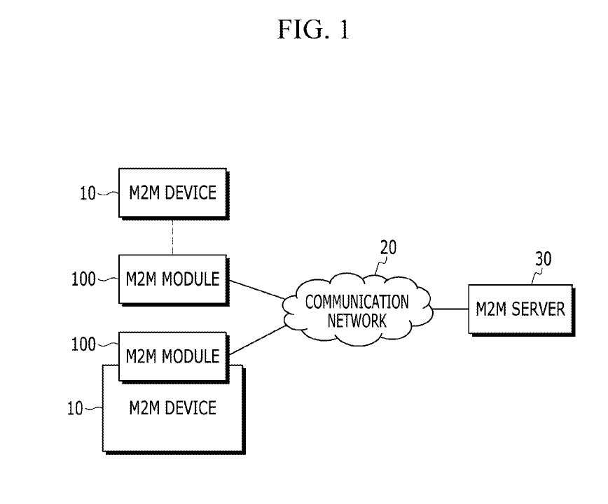

FIG. 1 is a view illustrating a machine to machine (M2M) communication system according to an exemplary embodiment of the present invention.

Referring to FIG. 1, in the M2M communication system, M2M modules 100 are connected to an M2M service server 30 through a wired/wireless communication network 20. M2M devices 10 are connected to the M2M modules 100, and the M2M modules 100 transmit data obtained by the M2M devices 10 to the M2M service server 30 through the communication network 20. At this time, the M2M modules 100 may be attached to and detached from the M2M devices 10, and may be included in the M2M devices 10.

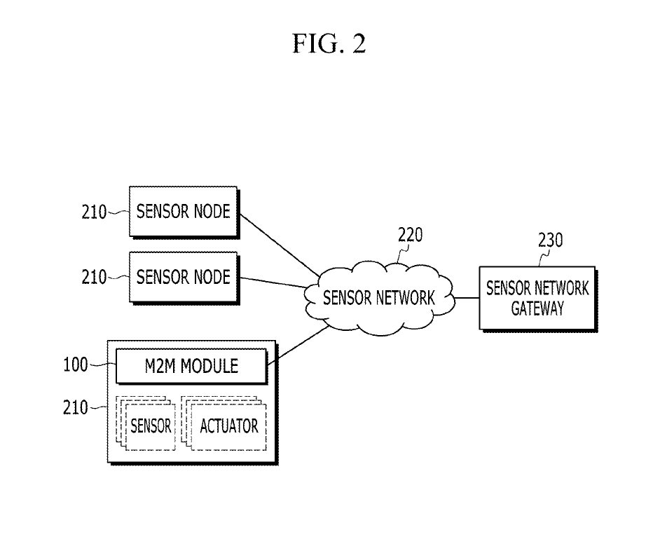

FIG. 2 is a view illustrating an M2M communication system applied to a sensor network system according to an exemplary embodiment of the present invention.

Referring to FIG. 2, sensor nodes 210 of the sensor network system are connected to a sensor network gateway 230 through a sensor network. Each of the sensor nodes 210 includes an M2M module 100, and may include at least one sensor or actuator. That is, since the sensor nodes 210 correspond to the M2M devices 10, data obtained by the sensors may be transmitted to the sensor network gateway 230 through a sensor network 220 using the M2M modules 100.

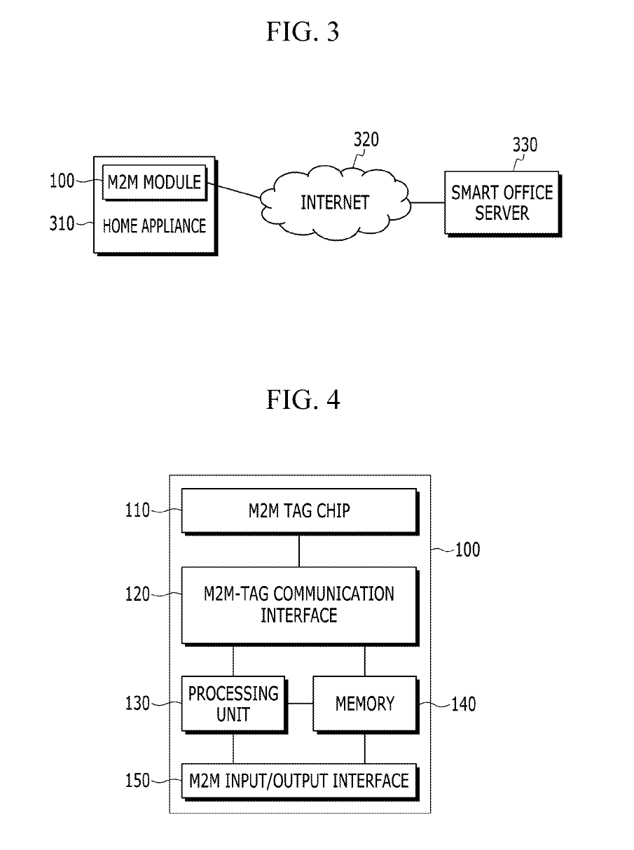

FIG. 3 is a view illustrating an M2M communication system applied to a home appliance 310 according to an exemplary embodiment of the present invention.

Referring to FIG. 3, a home appliance 310 is connected to a smart office server 330 (corresponding to the M2M service server 30) through the Internet 320. Home appliances 310 may include the M2M modules 100, and the home appliances 310 correspond to the M2M devices 10. The home appliances 310 may transmit data by remote control to the smart office server 330 through the Internet using the M2M modules 100.

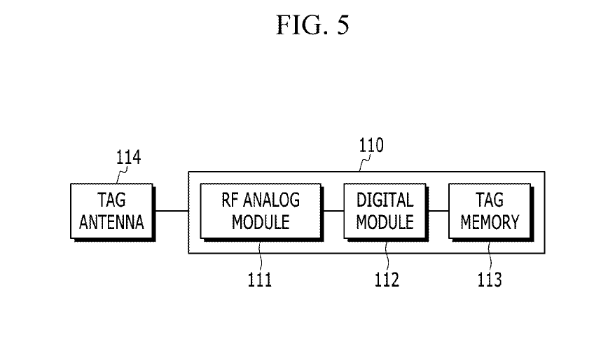

FIG. 4 is a block diagram illustrating an M2M module according to an exemplary embodiment of the present invention, and FIG. 5 is a block diagram illustrating an M2M tag chip according to an exemplary embodiment of the present invention.

Referring to FIG. 4, the M2M module 100 according to an exemplary embodiment of the present invention includes the M2M tag chip 110, an M2M-tag communication interface 120, a processing unit 130, a memory 140, and an M2M input/output interface 150. Referring to FIG. 5, the M2M tag chip 110 includes a radio frequency (RF) analog module 111, a digital module 112, and a tag memory 113, and may be connected to a tag antenna 114.

Referring to FIG. 4, the M2M-tag communication interface 120 functions as a communication interface between the processing unit 130 and the M2M tag chip. At this time, the M2M-tag communication interface 120 may be realized by a serial method such as a universal asynchronous receiver transmitter (UART), a serial peripheral interface (SPI), and an inter-integrated circuit (I²C), or may be realized by a parallel method such as an industry standard architecture (ISA) and an advanced technology attachment (ATA).

The processing unit 130 sets up the M2M module 100 based on a configuration stored in the M2M tag chip 110.

The memory 140 stores the configuration read from the tag memory 113, and may store temporary information that may be generated for operation time of the M2M module 100.

The M2M input/output interface 150 connects the M2M module 100 and the M2M device, or may connect the M2M module 100 to a communication network.

On the other hand, unlike other elements of the M2M module 100, the M2M tag chip may record data in the tag memory 113 or may inquire of recorded content by a radio frequency (RF) received from a radio frequency identification (RFID) reader even if power is not supplied to the M2M module 100.

The tag antenna 114 may transmit and receive an RF signal to and from the RFID reader, and the RF analog module 111 may transmit and receive an RF signal to and from the tag antenna 114.

The digital module 112 may convert the signal received from the RF analog module 111 into a digital signal.

The tag memory 113 may inquire or record data in accordance with the converted digital signal. The configuration of the M2M module 100 or an identifier of the M2M tag chip 110 may be stored in the tag memory 113.

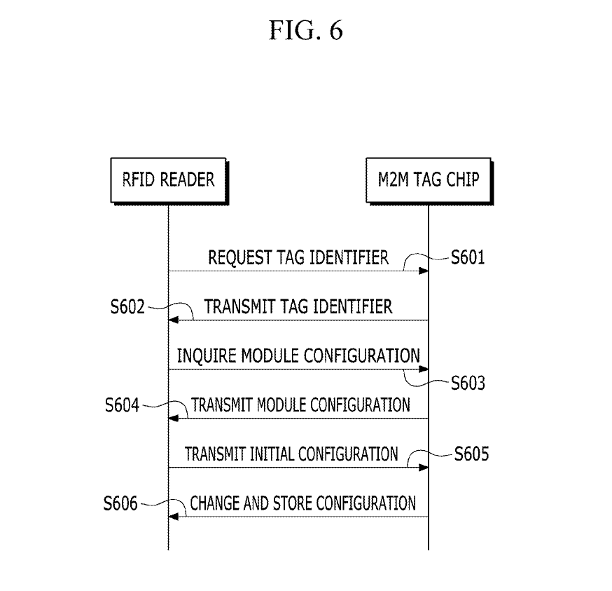

FIG. 6 is a flowchart illustrating processes of inquiring and setting up a configuration of an M2M tag chip 110 according to an exemplary embodiment of the present invention. That is, FIG. 6 illustrates a method of recording the configuration in the M2M module 100 through the RFID reader.

The configuration recorded in the M2M module 100 is a set value required when the M2M device transmits and receives data through the communication network. For example, in the case of the sensor network system of FIG. 2, when data sensed by a sensor node 210 is transmitted to the sensor network gateway 230, a configuration such as an identifier of the corresponding sensor node 210, a routing protocol of the sensor network 220, a duty cycle, a data transfer rate, or a sensing interval must be previously set up.

First, when the RFID reader requests the M2M tag chip 110 for a tag identifier in order to identify the M2M tag chip 110 built in the M2M module 100 (S601), the M2M tag chip 110 transmits the tag identifier recorded in the tag memory 113 to the RFID reader (S602).

Then, the RFID reader that identifies the M2M tag chip 110 through the tag identifier inquires of the configuration of the M2M module 100 recorded in the tag memory 113 (S603), and the M2M tag chip 110 transmits the configuration of the M2M module 100 to the RFID reader (S604).

Then, the RFID reader changes the configuration of the M2M module 100 into an initial configuration to transmit the initial configuration to the M2M tag chip 110 (S605), and the M2M tag chip 110 changes the configuration of the M2M module 100 in accordance with the initial configuration to store the changed configuration in the tag memory 113 (S606).

At this time, the M2M module 100 may transmit whether the configuration is successfully changed to the RFID reader, and when power is supplied to the M2M module 100 so that the processing unit 130 is operated, the M2M tag chip 110 may directly report to the processing unit 130 that the configuration is changed through the M2M-tag communication interface 120.

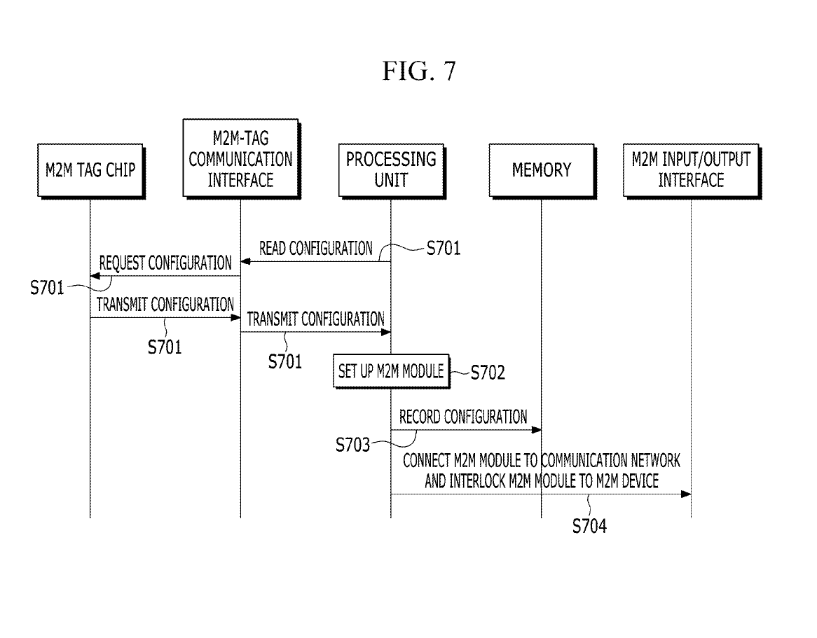

FIG. 7 is a flowchart illustrating processes of initially setting up an M2M module according to an exemplary embodiment of the present invention.

Processes of initially setting up the M2M module 100 performed by the processing unit 130 reading the configuration set up in the M2M tag chip 110 after power is supplied to the M2M module 100 will be described with reference to FIG. 7.

Referring to FIG. 7, after power is supplied to the M2M module 100, the processing unit 130 accesses the M2M tag chip 110 through the M2M-tag communication interface 120. That is, the processing unit 130 reads the configuration stored in the tag memory 113 through the M2M tag communication interface 120 (S701).

Then, the processing unit 130 sets up the M2M module 100 using the configuration read from the M2M tag chip 110 through the M2M-tag communication interface (S702).

Then, the processing unit 130 records the initial configuration in the memory 140 (S703), and may connect the M2M module 100 to the communication network or may interlock the M2M module 100 to the M2M device through the M2M input/output interface 150 (S704).

That is, if the M2M module 100 according to an exemplary embodiment of the present invention is built in the sensor node, when power is not supplied to the sensor node (e.g., in a factory initialization state), the configuration may be recorded in the M2M tag chip 110 using the RFID reader, and then, when power is supplied to the sensor node, the M2M device such as the sensor node 210 may be initially set up using the configuration recorded in the M2M tag chip.

Table 1 illustrates the configuration of the sensor node recorded in the M2M tag chip according to an exemplary embodiment of the present invention.

TABLE 1

| Division | value |
|---|---|
| Sensor Node ID | 123 |
| Sensor Network Gateway ID | SNG0001 |
| Duty Cycle | 1024 (milliseconds) |
| Data Transfer Rate | 100 (kbps) |
| Network Routing Protocol | Tree |
| Number of Sensor | 2 |
| Sensor 1 Type | Temperature |
| Sensor 1 Sensing Cycle | 60,000 (milliseconds) |
| Sensor 2 Type | Humidity |
| Sensor 2 Sensing Cycle | 60,000 (milliseconds) |

According to an exemplary embodiment of the present invention, although power is not supplied to the sensor node, the configuration of the sensor node illustrated in Table 1 may be stored in the tag memory 113 of the M2M tag chip 110 using the RFID reader.

In addition, the configuration value illustrated in Table 1 may be expressed by the following character stream.

SNID=123:SGNID=SNG0001:DC=1024;DTR=100;NRP=T;N=2;S1=(T,60000):, S2=(H.60000)

Then, when power is supplied to the sensor node 210, the M2M module 100 may be initially set up in accordance with the above configuration stored in the tag memory 113.

For example, when the M2M module 100 is set up in accordance with the configuration illustrated in Table 1, the sensor node including the M2M module 100 is connected to the sensor network gateway 220 whose identifier is SNG0001 in a sensor network routing structure in the form of a tree to be awakened every 1,024 milliseconds, to sense temperature and humidity values every 60 seconds, and to transmit data with a data transfer rate of 100 kbps.

According to another exemplary embodiment of the present invention, a configuration stored in an M2M tag chip may be changed in accordance with a control command from an M2M service server received through a communication network.

For example, in order to change configurations of a plurality of M2M modules 100 connected to an M2M service server through a communication network, the M2M service server transmits a configuration change command to processing units 130 through M2M input/output interfaces 150. Then, the processing units 130 set up the M2M modules 100 in accordance with the changed configurations, and may record the changed configurations in tag memories 113 of the M2M tag chips.

As described above, according to an exemplary embodiment of the present invention, the M2M modules may read the configurations recorded in the tag memories of the M2M tag chips, and may change the read configurations to be suitable for operation environments of the M2M devices. When an RFID technology is used, although wired power is not applied to RFID tags, since the RFID tags may be identified and data may be recorded using an RF, when the M2M devices are forwarded, the configurations of the M2M devices may be previously stored in the M2M tag chips. That is, without accessing the M2M devices through the communication network to record and change the configurations of the M2M devices when power is applied to the M2M devices, the configurations may be recorded in the M2M tag chips when the M2M devices are forwarded, and at this time, the M2M modules may set up the M2M devices through the recorded configurations.

In addition, since the RFID technology capable of simultaneously controlling the plurality of RFID tags for a short time is used, when the plurality of M2M devices are forwarded, the same configuration may be recorded in the M2M devices or identifiers may be designated to the M2M devices.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of recording an initial configuration in a machine to machine (M2M) tag chip through a radio frequency identification (RFID) reader, comprising:
transmitting an identifier of an M2M module including the M2M tag chip or a configuration of the M2M module to the RFID reader;
receiving the initial configuration determined based on the identifier or the configuration from the RFID reader; and
changing the configuration of the M2M module into the initial configuration and storing the initial configuration.

2. The method of claim 1, further comprising
informing the RFID reader whether a change into the initial configuration is successfully performed.

3. The method of claim 1, further comprising
informing a processing unit included in the M2M module whether the change into the initial configuration is successfully performed after power is supplied to the M2M module.

4. A method of setting up an M2M module through an initial configuration stored in an M2M tag chip included in the M2M module, comprising:
reading the initial configuration after power is applied to the M2M module;
setting up the M2M module based on the read initial configuration; and
connecting the M2M module to an M2M network in accordance with the set up initial configuration.

5. The method of claim 4, further comprising
storing the set up initial configuration.

6. An M2M module for connecting an M2M device and an M2M network, comprising:
an M2M tag chip configured to store an initial configuration for setting up the M2M module;
a processing unit configured to read an initial configuration from the M2M tag chip after power is applied to the M2M module, and configured to set up the M2M module based on the read initial configuration; and
an M2M-tag communication interface configured to connect the M2M tag chip and the processing unit.

7. The M2M module of claim 6, wherein the M2M tag chip is connected to a tag antenna configured to transmit and receive a radio frequency (RF) signal to and from a radio frequency identification (RFID) reader, and comprises:
an RF analog module configured to transmit and receive an RF signal to and from the tag antenna;
a digital module configured to convert the signal transmitted by the RF analog module into a digital signal; and
a tag memory configured to store a configuration of the M2M module in accordance with the digital signal.

8. The M2M module of claim 7, wherein the tag memory may inquire or record data in accordance with the digital signal, and stores an identifier of an M2M tag chip.

9. The M2M module of claim 6, wherein the processing unit connects the set up M2M module to the M2M network based on the initial configuration.

10. The M2M module of claim 6, wherein an M2M-tag communication interface connects the M2M tag chip and the processing unit by a serial method such as a universal asynchronous receiver transmitter (UART), a serial peripheral interface (SPI), and an inter-integrated circuit (I²C), or a parallel method such as an industry standard architecture (ISA) and an advanced technology attachment (ATA).

11. The M2M module of claim 6, further comprising
a memory configured to store the initial configuration and temporary information that may be generated for operation time of the M2M module.

12. The M2M module of claim 6, further comprising
an M2M input/output interface configured to connect the M2M device and the M2M network and the M2M module.
